(19) United States
(12) Patent Application Publication
(10) Pub. No.: US 2004/0013246 A1
(43) Pub. Date: Jan. 22, 2004

(54) System and method for modifying display formation of mobile phone

(76) Inventors: Gap-Chun Back, Gyeonggi-do (KR); Seung-Hyouk Yim, Seoul (KR); Chil-Hyun Baek, Seoul (KR); Terry Ahn, Seoul (KR)

Correspondence Address: Finnegan Henderson Farabow, Garrett & Dunner, 1300 I Street N W, Washington, DC, 20005-3315, US

(21) Appl. No.: 10/257,146

(22) PCT Filed: Mar. 13, 2002
(86) PCT No.: PCT/KR02/00430

(30) Foreign Application Priority Data
Sep. 10, 2001 (KR) 2001-0055440

(51) Int. Cl. H04M 1/64; H04M 1/00

(52) U.S. Cl. 379/88.17; 455/566; 379/93.17

(57) ABSTRACT

The present invention relates to a display structure modification system and its method characterized by receiving a display structure modification command from the user, searching and indicating at least one display structure data previously stored on the display of the telecommunication apparatus, and modifying the screen establishment of the telecommunication apparatus into the display structure data corresponding to the selection command to any display structure data inputted by the user. The present invention provides the method that the display structure of the liquid crystal display is diversely constructed according to the user's individuality and the method that conveniences of the usage of the user's mobile telecommunication terminal are sought after by enabling an application hotkey establishment to be set up according to the user's intent.

### TECHNICAL FIELD

The present invention relates to a display structure modification system and its method of a mobile telecommunication terminal. Particularly, the present invention relates to the display structure modification system and its method of a mobile telecommunication terminal for modifying the display structure of the mobile telecommunication terminal arbitrarily according to user's usage intent.

### BACKGROUND ART

Mobile telecommunication terminal users are inclined to attach stickers or ornaments onto their mobile telecommunication terminals according to their unique tastes and individualities. Users are able to change the external form of their mobile telecommunication terminals with unique shapes or colors or use sticker photographs as Liquid Crystal Display (LCD)'s background screens for their mobile telecommunication terminals.

This inclination is due to the recent change in popular opinion that the mobile telecommunication terminal is more than just a useful and convenient tool. It is now viewed as an accessory for showcasing one's individualities.

Due to this inclination, the manufacturers of mobile telecommunication terminals are trying to improve the user's ability to download and designate a LCD background screen arbitrarily through the communication net.

However, a disadvantage occurs because only the beauty of the images applicable as the prior LCD's background screen is emphasized, not the conveniences of the mobile telecommunication terminal.

Furthermore, the usual standby screen indicated on the liquid crystal display of the mobile telecommunication terminal includes simple images, the date and the time and therefore is inconvenient for the user to access the desired menu by operating separate menu keys.

Furthermore, there is the disadvantage that it is not easy for the users to set up or modify hotkey establishments suitable to themselves arbitrarily because the establishments of application hotkeys for function operations in the prior mobile telecommunication terminal are fixed when sent out.

### DISCLOSURE OF INVENTION

Therefore, the objective of the present invention is to provide a display structure modification system and its method of a mobile telecommunication terminal whose LCD's display structure can be diversely constructed according to the user's individuality.

Another objective of the present invention is to provide a display structure modification system and its method of a mobile telecommunication terminal to seek the convenience of the user's mobile telecommunication terminal by enabling an application hotkey establishment to be set up according to the user's intent.

Another objective of the present invention is to provide a display structure modification system and its method of a mobile telecommunication terminal for enabling the user to designate the desired icon, enabling certain application to be executed in case of designating the icon, and enabling the user to arrange the location.

Another objective of the present invention is to provide a display structure modification system and its method of a mobile telecommunication terminal for executing the application desired by the user without operation of complex menu keys by arranging icons which enable application execution in a usual standby screen indicated on the liquid crystal display of the mobile telecommunication terminal.

To achieve these objectives, the present invention provides a method of modifying a display structure of a telecommunication apparatus, comprised of the steps of receiving a display structure modification command inputted by a user, searching at least one display structure data previously stored, indicating on the display of the telecommunication apparatus to correspond to the display structure data, receiving a selection command to any display structure inputted by the user, and modifying a screen establishment of the display into the display structure corresponding to the selection command, an apparatus and a recording medium capable of executing the above-mentioned method.

Furthermore, the display structure includes at least one among an application image area, an application name area and an application icon area, and the telecommunication terminal is a mobile telecommunication terminal or PDA.

Furthermore, the method of modifying the display structure is comprised of the steps of receiving a connection command to a web server which provides the display structure data from the user, executing a connection to the web server through the communication net corresponding to the connection command, receiving at least one display structure data from the web server, indicating on the display to correspond to the received display structure data, receiving a download command of any display structure data among the indicated display structure data inputted by the user, requesting the transfer of the display structure data corresponding to the download command to the web server through the communication net, receiving the display structure, and storing the received display structure data.

Furthermore, the method of modifying the display structure is comprised of the steps of receiving a execution start command of the apparatus from the user, searching the modified display structure, and indicating on the display of the telecommunication apparatus to correspond to the display structure data.

According to one preferable embodiment of the present invention, the present invention provides a method of establishing icons to be indicated on the display of a telecommunication apparatus, comprised of the steps of receiving a list indication command of an application capable of being executed by the telecommunication apparatus from the user, creating the list including at least one application capable of being executed by the telecommunication apparatus, indicating the created list on the display, receiving a selection command to any application among the application included in the list, searching one previously stored icon data capable of being designated corresponding to the application, indicating the searched icon data on the display, receiving an selection command to any icon data among the indicated icon data from the user, establishing a connection between the selected application and the selected icon data, and indicating the icon data on the display corresponding to the application, an apparatus and a recording medium capable of executing the above-mentioned method.

Furthermore, the method is comprised of the steps of receiving a connection command to a web server providing an additional data from the user, executing a connection to the web server corresponding to the connection command through the communication net, receiving at least one additional data from the web server, indicating the received additional data on the display, receiving a download command to any additional data among the indicated additional data from the user, requesting the transfer of the additional data corresponding to the download command to the web server through the communication net, receiving the additional data, and storing the received additional data and the additional data are icon data or additional application data.

According to another preferable embodiment of the present invention, the present invention provides a method of modifying the arrangement of icons indicated on a display of a telecommunication apparatus corresponding an application capable of being executed in the telecommunication apparatus, comprised of the steps of receiving an icon arrangement modification command from the user, searching previous icon arrangement data being indicated on the display of the telecommunication apparatus, indicating at least one application designation data (for example, an application name and the icon) in a predefined way by using the icon arrangement data on the display of the telecommunication apparatus, wherein the application designation data includes one of an application name and the icon, receiving a selection command to any application designation data among the application designation data from the user, receiving a location modification data to modify a display location of the display of the telecommunication apparatus corresponding to the selected application designation data, storing the location modification data to correspond to the application designation data, and arranging the icon on the display of the telecommunication apparatus by using the location modification data, a system and an apparatus capable of executing the above-mentioned method.

According to another preferable embodiment of the present invention, the present invention provides a method of providing a display structure modification data (for example, display structure data, additional application data, and icon data) to be capable of modifying the display structure of the user's telecommunication apparatus through a communication net, comprised of the steps of receiving a connection request from the telecommunication apparatus, transferring a list of the display structure modification data to the telecommunication apparatus, wherein the display structure modification data include at least one among display structure data, additional application data and icon data, receiving an transfer request of any display structure modification data from the telecommunication apparatus, and transferring the display structure modification data corresponding to the transfer request to the telecommunication apparatus, a system and an apparatus capable of executing the above-mentioned method using the communication net.

### BRIEF DESCRIPTION OF DRAWINGS

FIG. 1 shows a simple construction of an application designation icon supply system according to one preferable embodiment of the present invention;

FIG. 2 is a flowchart illustrating the method of modifying the LCD's display structure according to the preferable embodiment of the present invention;

FIGS. 3a-3d are exemplary screen indications outputted during the step of modifying the LCD's display structure;

FIG. 4 is a flowchart illustrating the method of establishing an application icon according to the preferable embodiment of the present invention;

FIGS. 5a-5e are exemplary screen indications outputted during the step of establishing an application icon according to the preferable embodiment of the present invention;

FIG. 6 is a flowchart illustrating the method of modifying the location of the application icon according to the preferable embodiment of the present invention; and

FIGS. 7a-7e show the exemplary screen indications outputted when the location of the application icons are modified.

### DESCRIPTION OF SYMBOL ABOUT MAIN PARTS OF THE DRAWINGS

110: personal computer

120: Inter-Working Function (IWF)

130: icon management system

140: icon storage unit

150: Mobile Switching Center (MSC)

160: Visitor Location Register (VLR)

165: Home Location Register (HLR)

170: Base Station Controller (BSC)

180: Base Transceiver Station (BTS)

190: mobile telecommunication terminal

Best Mode for Carrying Out the Invention

Embodiments of the present invention will now be described by way of example and with reference to the accompanying drawings.

For applying the present invention, there are several methods to designate ranges of display structures and icons selectable according to the user's intent as shown below:

The first method is that several display structures and icons are stored in the storage unit of the mobile telecommunication terminal in manufacturing the mobile telecommunication terminal.

The second method is that the user accesses a web server to execute icon supply services through the communication net, receives the desired display structure and icon through the communication net and stores them in the mobile telecommunication terminal.

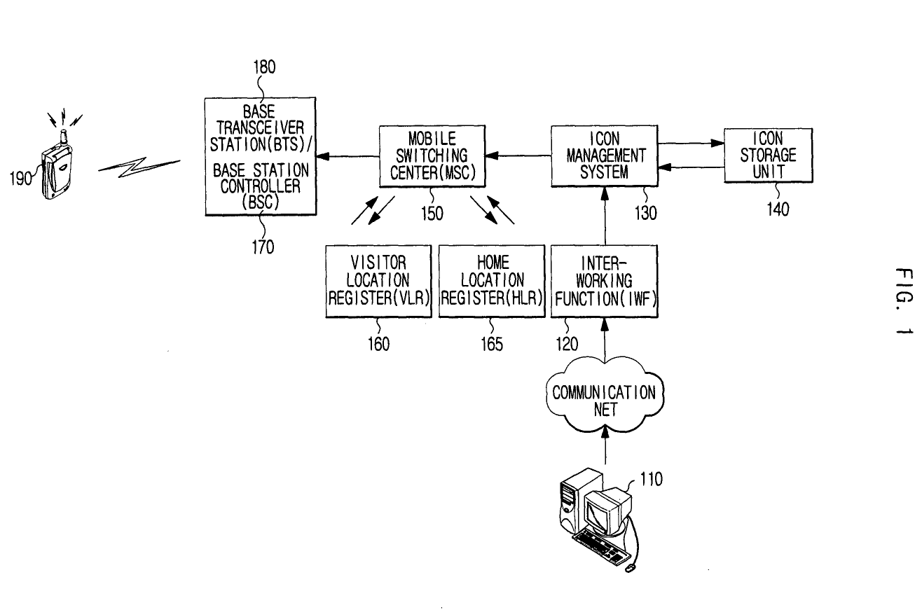

When the present invention will be disclosed with reference to FIG. 1, the above-described second method will be in priority disclosed.

Furthermore, even though the display structure and icon indicated on the liquid crystal display of the mobile telecommunication terminal will be in priority disclosed, the same technical thought can be also applied to Personal Digital Assistants (PDA).

FIG. 1 shows a simple construction of an application designation icon supply system according to the preferable embodiment of the present invention.

FIG. 1 shows the process of accessing the web server which executes the icon supply services by using the personal computer communicated with the communication net and receiving the desired display structures or icons.

The user can access the web server with the user's mobile telecommunication terminal and execute the same work, but the former method is similarly applicable to this method and then the description of this method will be omitted.

Referring to FIG. 1, an application designation icon supply system is comprised of a personal computer 110, an Inter-Working Function (IWF) 120, an icon management system 130, an icon storage unit 140, a Mobile Switching Center (MSC) 150, a Visitor Location Register (VLR) 160, a Home Location Register (HLR) 165, a Base Station Controller (BSC) 170, a Base Transceiver Station (BTS) 180 and a mobile telecommunication terminal 190.

In the case that a user wants to download a display structure or an icon into the user's mobile telecommunication terminal, the user can access the icon management system 130 with the personal computer 110 and it's communication the communication net.

Also, the icon management system 130 can be constructed as an apparatus separate from the previous Short Message Service Center (SMSC) and the economical system construction without requiring additional apparatuses and can be achieved by adding icon management function to the previous Short Message Service Center (SMSC).

At this time, the operation of the Inter-Working Function (IWF) 120 makes a connection between the personal computer 110 and the icon management system 130 possible.

The Inter-Working Function (IWF) 120 enables the mobile telecommunication terminal to transmit and receive data without an additional wireless modem and makes the connections among the mobile telecommunication terminal, the internet and the communication net.

When the personal computer 110 and the icon management system 130 are connected through the communication net, at least one display structure or one icon which is stored in the icon storage unit 140 and can be selected by the user for downloading and is indicated on the screen of the personal computer 140.

If the user selects any display structure or icon and inputs the telephone numbers of the mobile telecommunication terminal for receiving the selected display structure or icon, the user's display structure selection data (or icon selection data) and receipt number data are transmitted to the icon management system 130 through the communication net.

The icon management system 130 refers to a display structure data (or icon data) corresponding to the selected display structure (or icon) within the icon storage unit 140 and transmits the referred display structure data (or icon data) to the Mobile Switching Center (MSC) 150 together with the receipt number from the personal computer 110.

The Mobile Switching Center (MSC) 150 grasps the location of the mobile telecommunication terminal requiring the receipt of the display structure data (or icon data) with the Visitor Location Register (VLR) 160 and the Home Location Register (HLR) 165 and transmits the display structure data (or icon data) to any suitable Base Transceiver Station (BTS) 180.

The Visitor Location Register (VLR) 160 provides services from the area allotted thereto to the other area, and the Home Location Register (HLR) 165 writes and maintains the information of the subscribers staying within the mobile telecommunication service subscriber residence area.

The Mobile Switching Center (MSC) 150 accesses the Base Transceiver Station (BTS) 180 and processes and repeats calls for the mobile telecommunication service subscriber.

Base Transceiver Station (BTS) 180 the transmits the display structure data (or icon data) received from the Mobile Switching Center (MSC) 150 by the control of the Base Station Controller (BSC) 170 to the mobile telecommunication terminal 190 having the receipt number.

The Base Station Controller (BSC) 170 maintains 8 and over Base Transceiver Stations (BTS) 180 and compresses 64 kbps voice PCM signal into 8 kbps and below by the IS-96 voice compression algorism during the connection to the mobile telecommunication terminal 190.

Furthermore, the Base Transceiver Station (BTS) 180 controls the calling and answering of the mobile telecommunication terminal within the cell maintained by one Base Transceiver Station and maintains the wireless channels within the self-Base Transceiver Station.

The user can then utilize the display structure data (or icon data) stored in the storage unit of the mobile telecommunication terminal 190 for the display structure establishment, specific application designation and so on.

Additional items (for example, the background screen for the liquid crystal display of the mobile telecommunication terminal, the telephone bell sound, and so on) are downloaded through the web server of the mobile telecommunication operator. Therefore, when disclosing the present invention, the process of downloading a display structure or an icon will be briefly disclosed.

Also, the provision of the display structure or the icon according to the present invention to the normal user may be charged or free according to the standards like transmission times and use time.

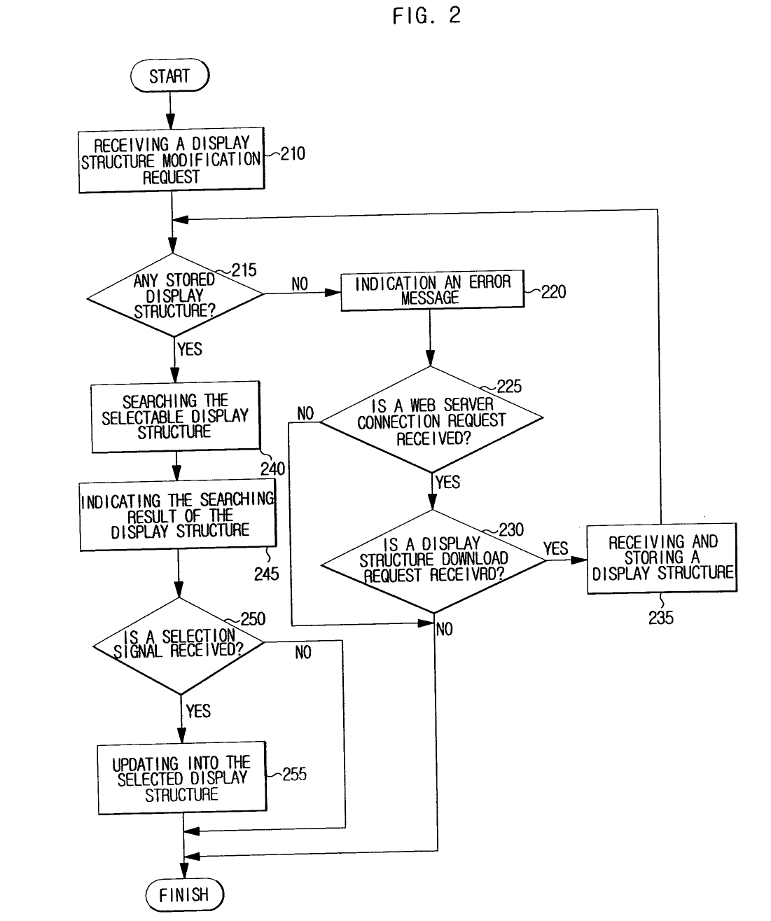

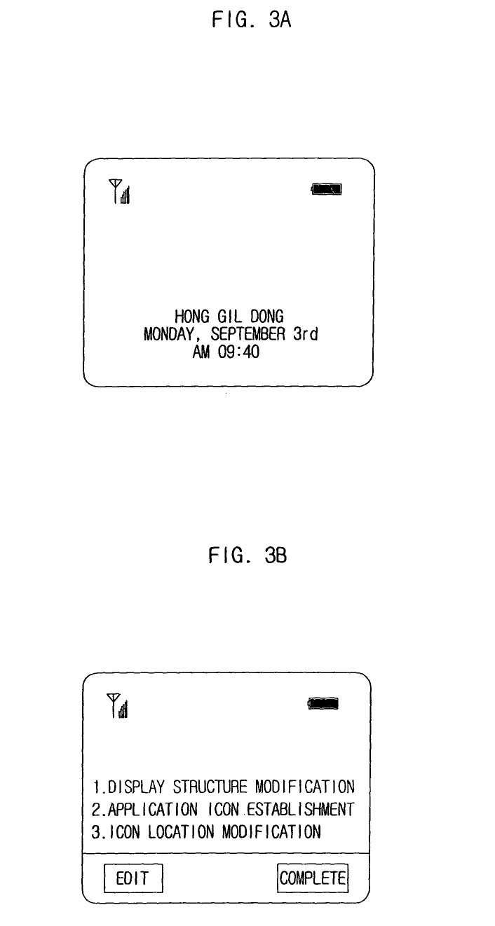

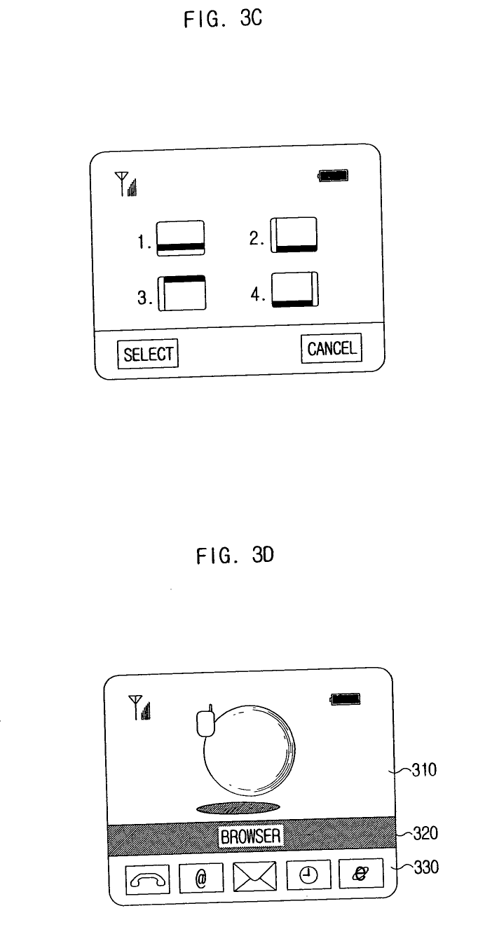

FIG. 2 is a flowchart illustrating the method of modifying the LCD's display structure according to the preferred embodiment of the present invention, and FIGS. 3a-3d are exemplary screen indications outputted during the step of modifying the LCD's display structure.

For disclosing the method of changing the LCD's display structure according to the present invention, the relevant flowcharts and the exemplary screen indications are together disclosed for the convenience of understanding the present invention.

The LCD's display structure of a general mobile telecommunication terminal is similar to that of FIG. 3a. That is, the display structure is comprised of an antenna that indicates whether an area is ready for receiving, a battery that indicates the condition of power, one line into which the user can input any simple character (for example, the character ‘Hong Gil Dong’ was inputted in FIG. 3a), one line that indicates a date and a day of the week, and one line that indicates time.

However, it is a disadvantage that the above-described display structure is simple and is limited in the range of modification thereof according to the user's intents of the mobile telecommunication terminal.

Also, the initial screen establishment method using pictures, which is a generalized method, seems to be modifiable according to the user's intent at first sight, but the initial screen is only replaced in practice. Therefore, in the case that the user of the mobile telecommunication terminal inputs telephone numbers, the picture disappears and only the telephone numbers inputted by the user is outputted on the liquid crystal display.

However, the modification of the display structure of the present invention is not limited in the modification of the initial screen. The present invention provides a method for the user to modify the display structure freely.

Referring to FIGS. 2, 3b-3d, the display structure modification method according to the present invention will be described.

And, even though the steps of FIG. 2 are executed in the controller and the input receiver within the mobile telecommunication terminal in practice, by commonly designating that the steps are executed by the mobile telecommunication terminal, the steps will be described.

Referring to FIG. 2, in the step 210, a display structure modification request from the user is inputted to the mobile telecommunication terminal.

That is, referring to FIG. 3, in the case that the menus of ‘1. Display structure modification, 2. Application icon establishment, 3. Icon location modification’ are indicated on the liquid crystal display of the mobile telecommunication terminal, FIG. 3 is a screen indication that the user selects the menu of ‘1. Display structure modification’.

Referring to FIG. 2, in the step 215, the mobile telecommunication terminal checks whether there is any display structure previously stored in the storage unit thereof.

According to the check result of the step 215, unless there is any stored display structure in the mobile telecommunication terminal, the flow proceeds to the step 220.

In the step 220, an error message (for example, such as ‘there is no display structure stored, and new display structure can be downloaded through the web server.’) is indicated on the liquid crystal display of the mobile telecommunication terminal. Also, in the step 220, the flow doesn't proceed any more and may finish.

In the step 225, the mobile telecommunication terminal checks whether any connection request to the web server is inputted from the user through the communication net.

Most of the mobile telecommunication terminals presently circulated are embodied to enable the user's internet connection, and in the case that the user tries to connect the mobile telecommunication terminal to the web server, the Inter-Working Function (IWF) 120 makes the connection between the mobile telecommunication terminal and the web server possible.

According to the check result of the step 225, if a web server connection request from the user is inputted, the flow proceeds to the step 230 and the flow finishes. This occurs even if it does not happen.

In the step 2)30 the mobile telecommunication terminal checks whether any download request to any display structure from the user is inputted.

According to the check result of the step 230, if a download request to a display structure from the user is inputted, the step 235 proceeds and the flow finishes. This occurs even if it does not happen.

In the step 235, the mobile telecommunication terminal downloads the display structure selected by the user and stores into the storage unit and then the flow proceeds to the step 215.

The display structure disclosed in the steps 225-235 can be downloaded through the mobile telecommunication terminal and through the personal computer as been described in FIG. 1.

Referring to the step 215, according to the check result of the step 215, if any display structure selectable by the user is stored in the storage unit, and the flow proceeds to the step 240 and the user can search the selectable display structures.

In the step 245, the mobile telecommunication terminal indicates at least one display structure, which was searched in the step 240, on the liquid crystal display.

In the step 250, the mobile telecommunication terminal checks whether any selection signal to a display structure from the user is inputted, and if a selection signal is inputted, the flow proceeds to the step 255, and then the process of updating to the display structure selected by the user is executed and the step finishes.

However, according to the check result of the step 250, unless any selection signal is inputted, the previous display structure is maintained and the step finishes. Also, in this case, instead of finishing the step, the process of waiting a selection signal from the user until inputted may be executed.

The selectable display structure list of the step 245 is shown in FIG. 3c.

The user selects and inputs the number representing the desired display structure among at least one display structure, and modifies the display structure into the desired.

If the user selects the first display structure among at least one display structure shown in FIG. 3c, the display structure of FIG. 3d is indicated on the liquid crystal display of the user's mobile telecommunication terminal.

The display structure of the liquid crystal display according to the present invention like FIG. 3d is divided into an application image area 310, an application name area 320 and an application icon area 330.

The application image area 310 is an image screen representing a specific application and the image screen is capable of being modified by the user's establishment, and the image is capable of being downloaded through the communication net.

Also, whenever the user moves the icons in order within the application icon area 330 with left and right direction keys to select an application, the image in the application image area 310 is modified into the image corresponding to the movement.

The application name area 320 indicates titles of the applications, and whenever the user moves the icons in order within the application icon area 330 with left and right direction keys to select an application like the application image area 310, the application name is modified into the application name corresponding to the movement and outputted.

The application icon area 330 indicates application icons. The basically built-in application icons are indicated in the application icon area 330 and in the case of downloading additional applications from the web server and installing, the icons corresponding to the additional applications are added.

The application icons can be downloaded and installed in the application icon area 330 like the application image area 310. Furthermore, since the arrangement orders of each application icon can be modified, the user can make the application execution convenient by arranging the applications frequently being used in front.

This display structure is decided by the script stored in the storage unit of the mobile telecommunication terminal, and the fields that should be included are as shown below.

| Classification | Fields |
|---|---|
| Lay-out | Location and size of the application image area |
| | Location and size of the application name area |
| | Location and size of the application icon area |
| Application image area | Character of the background color |
| Application name area | Font of the background color, Font character |
| Application icon area | Character of the background color |

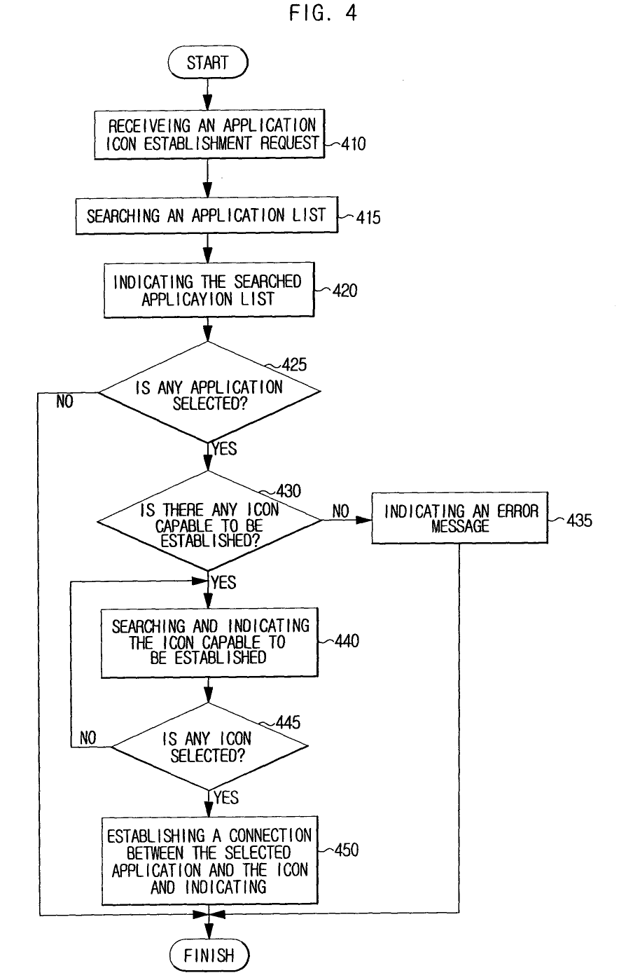

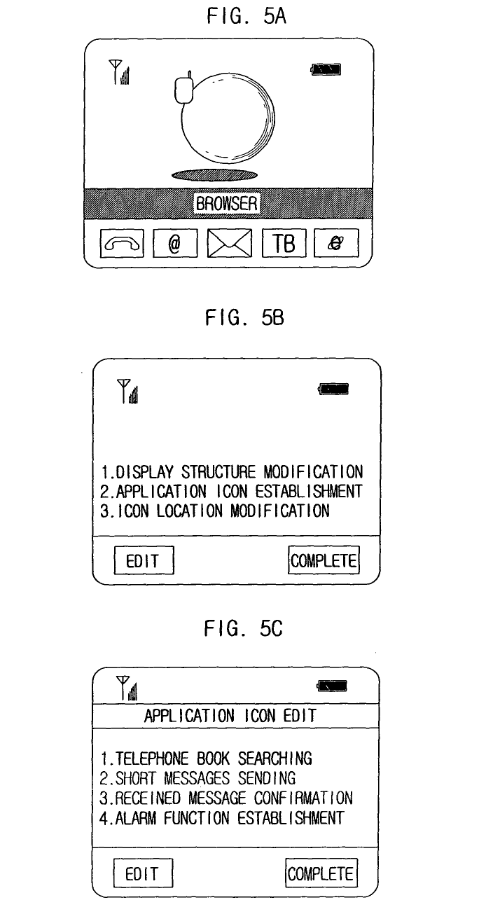

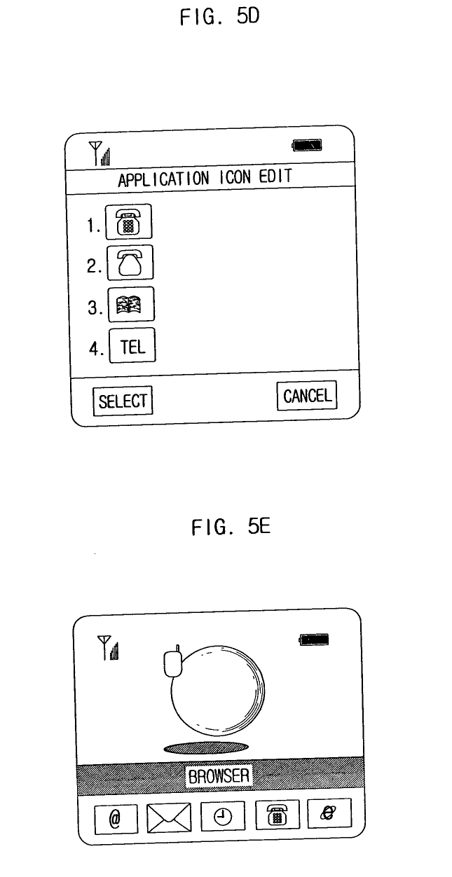

FIG. 4 is a flowchart illustrating the method of establishing an application icon according to the preferable embodiment of the present invention, and FIGS. 5a-5e are exemplary screen indications outputted during the step of establishing an application icon according to the preferable embodiment of the present invention.

FIG. 5a shows the form of the liquid crystal display screen to which the display structure explained referring to FIGS. 2, 3a-3d was applied. And, the in the case that the user modifies the telephone book (TB) icon among the several application icons included in the application icon area 330 of FIG. 5a into a different form of the icon will be explained for example.

Referring to FIG. 4, in the step 410, an application icon establishment request from the user is inputted into the mobile telecommunication terminal, and the flow proceeds to the step 415 and the mobile telecommunication terminal searches the application list including at least one application capable of being executed thereby.

And, the flow proceeds to the step 420, and the searched application list in the step 415 is indicated on the liquid crystal display of the mobile telecommunication terminal.

The screen indications outputted on the liquid crystal display of the mobile telecommunication terminal in the steps 410 and 420 are illustrated in FIGS. 5b and 5c.

That is, the step 140 is the case that when the menus of ‘1. Display structure modification, 2. Application icon establishment, 3. Icon location modification’ are indicated on the liquid crystal display of the user's mobile telecommunication terminal, the user selects the menu of ‘2. Application icon establishment’.

Also, by the step 410, the application list of ‘1. Telephone book searching, 2. Short messages sending, 3. Received message confirmation, 4. Alarm function establishment’ capable of being executed by the mobile telecommunication terminal is indicated in FIG. 5c.

Also, when the application list is indicated, each of the applications can be classified by serial numbers like FIG. 5c, or by icons established as basic icon together with the serial numbers (or without the serial numbers).

In the step 425, the mobile telecommunication terminal checks whether an application is selected by the user.

According to the check result of the step 425, if an application is selected by the user, the flow proceeds to the step 430, and the step finishes with the previous establishment maintained. This occurs even if it does not happen.

In the step 430, the mobile telecommunication terminal checks whether or not there is an icon capable of being established to correspond to the application which was selected by the user in the step 425.

According to the check result of the step 430, unless there is any icon capable of being established, the flow proceeds to the step 435, and an error message (for example, ‘there is no icon capable of being established. The icon can be downloaded through the web server.’) is indicated on the liquid crystal display of the mobile telecommunication terminal and then the step finishes.

Also, instead of finishing the step after the error message was indicated in the step 435, the step of downloading certain icons from the web server with the internet connection function of the mobile telecommunication terminal as being explained referring to FIG. 2 can be further included.

According to the check result of the step 430, if there is any icon capable of being established, and the flow proceeds to the step 440 and then the icon capable of being established, which is stored in the storage unit of the mobile telecommunication terminal, is searched and indicated on the liquid crystal display of the mobile telecommunication terminal.

By the step 440, the case that the icon capable of being established is indicated on the liquid crystal display of the mobile telecommunication terminal is illustrated in FIG. 5d. That is, FIG. 5d is the exemplary screen indication indicated on the liquid crystal display of the mobile telecommunication terminal in the case that the user selects the application of ‘1. Telephone book searching’ among the several application shown in FIG. 5c.

In the step 445, the mobile telecommunication terminal checks whether an icon corresponding to a specific application is selected by the user.

According to the check result of the step 445, if an icon is selected by the user, and the flow proceeds to the step 450, the flow stays at the step 440 until the selection of the user is inputted. This occurs even if it does not happen. Also, instead of proceeding to the step 440, the flow may finish.

In the step 450, the mobile telecommunication terminal establishes the connection between the application selected in the step 425 and the icon selected in the step 445, and indicates them on the liquid crystal display of the mobile telecommunication terminal.

The icon established in the step 450 is indicated on the liquid crystal display of the mobile telecommunication terminal.

And, comparing FIG. 5a with FIG. 5e, it is noted that in FIG. 5a, the icon in the form of ‘TB” is indicated, but in FIG. 5e, the icon was modified into the icon in the form of the image selected by the user of the mobile telecommunication terminal.

Furthermore, the application hotkey establishment and application execution method according to another preferable embodiment of the present invention is provided.

That is, in the case that the user wants the execution of a specific application, instead of searching the application on the list, the application can be executed at once with the application hotkey.

The method will be simply explained as shown below. If the user selects the desired application from the application manager (which may be one of the menus included in the mobile telecommunication terminal), and then selects the previously designated menu (for example, the menu of ‘shortcut with the right hotkey’), in the case that the left and right direction key is pressed on the specific icon in the application icon area 330, referring to FIG. 5a, the application can be executed at once.

Therefore, the direction key of the display structure according to the present invention has the function of the application hotkey to enable the application to be executed as well as the function of moving the focus to the left or right on the application icon area 330, referring to FIG. 5a.

For example, if the user presses the direction key short, the movement of the focus is executed within the application icon area 330, referring to FIG. 5a, or if the user presses the direction key long, the corresponding application is executed.

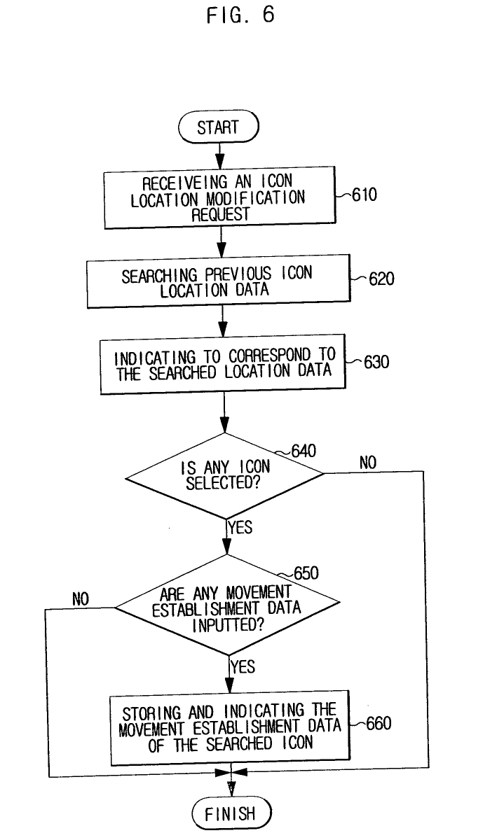

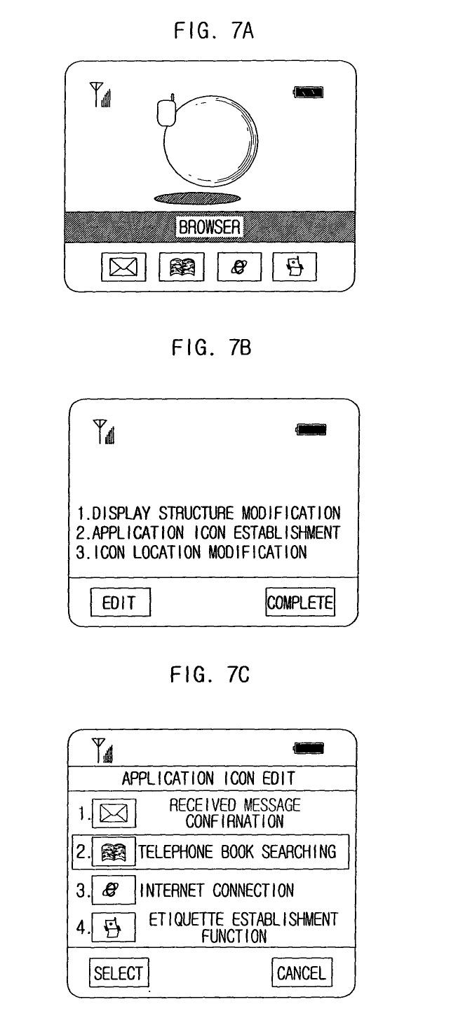

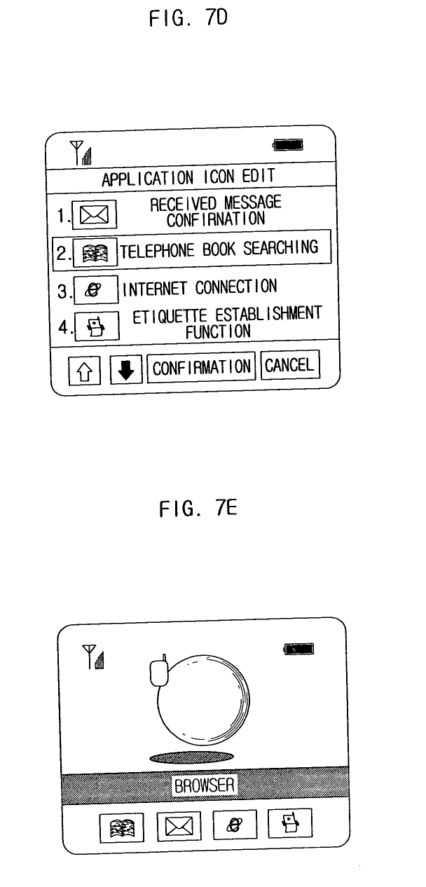

FIG. 6 is a flowchart illustrating the method of modifying the location of the application icon according to the preferable embodiment of the present invention, and FIGS. 7a-7e show the exemplary screen indications outputted when the location of the application icons are modified.

FIG. 7a illustrates the display structure of the liquid crystal display and the arrangement of the icons of the mobile telecommunication terminal according to the present invention as explained above. The icons in FIG. 7a are arranged in the order of a received message confirmation application icon, a telephone book searching application icon, an Internet connection application icon and an etiquette establishment function application icon.

Referring to FOG. 6, FIGS. 7b-7e, for explaining the method of modifying the location of the application icon, the case that the user modifies the arrangement order of the received message confirmation application icon and the telephone book searching application icon will be explained.

Referring to FIG. 6, in the step 610, an application icon location modification request is inputted into the mobile telecommunication terminal by the user, and the flow proceeds to the step 620, and the previous icon location data stored in the storage unit of the of the mobile telecommunication terminal is searched.

Referring to FIG. 7b, in the step 610, it is the case that the menus of ‘1. Display structure modification, 2. Application icon establishment, 3. Icon location modification’ are indicated on the liquid crystal display of the mobile telecommunication terminal, the user selects the menu of ‘3. Icon location modification’.

In the step 630, the mobile telecommunication terminal indicates the icon within the application icon area 330, referring to FIG. 3d, searched in the step 620 on the liquid crystal display of the mobile telecommunication terminal, and the flow proceeds to the step 640 and the mobile telecommunication terminal checks whether any icon is selected by the user.

Since the application icon area 330, referring to FIG. 3d, is comprised of a received message confirmation application icon, a telephone book searching icon, an Internet connection application icon and an etiquette establishment function application icon in order, each application list is indicated at the location corresponding to each icon in FIG. 7c.

Also, if the user selects ‘telephone book searching application icon’ among the application lists, the screen indication like FIG. 7d is outputted on the liquid crystal display of the mobile telecommunication terminal.

According to the check result of the step 640, if any icon is selected by the user, and the flow proceeds to the step 650, or if not, and the step finishes.

In the step 650, the mobile telecommunication terminal checks whether or not any movement establishment data are inputted by the user.

Referring to FIG. 7d, the upper and lower direction movement button is provided to modify the location of ‘Telephone book searching application icon’ selected by the user.

If the user selects the upper direction movement button, and the corresponding icon is located over the previous location thereof, and consequently is located at the front on the application icon area 330, referring to FIG. 3d (FIG. 7e illustrates that by the selection of the user's location movement button the location of ‘Telephone book searching application icon is modified).

However, if the user selects the lower direction movement button, the reverse result of the above case will occur.

Referring to FIG. 6, according to the check result of the step 650, if any movement establishment data for the icon selected by the user is inputted, and the flow proceeds to the step 660, and the movement establishment data for the corresponding icon are updated and stored. Then, the corresponding icon is indicated at the suitable location in the liquid crystal display with the movement establishment data of the updated corresponding icon.

In case of finishing the steps of FIG. 6, the screen indicated on the liquid crystal display is like that of FIG. 7e.

Industrial Applicability

As described above, the present invention provides the method that the display structure of the liquid crystal display is diversely constructed according to the user's individuality.

Furthermore, the present invention provides the method that makes it more convenient for the user by enabling an application hotkey establishment to be set up according to the user's intent.

Furthermore, the present invention provides the method that the user designates the desired icon, and a certain application is executed in the case of designating the icon, and the user can arrange the location of the icon on the liquid crystal display (LCD) freely.

Furthermore, the present invention provides the method that the application desired by the user can be executed by arranging icons which enables application execution in a usual standby screen indicated on the liquid crystal display of the mobile telecommunication terminal without operating complex menu key.

Furthermore, the present invention provides the user friendly screen and function and new positive spread model of the display structure using the communication net, the application icon and the image download.

What is claimed is:

1. A method of modifying the display structure of the telecommunication apparatus, comprising the steps of:
receiving a display structure modification command inputted by a user;
searching at least one display structure data previously stored;
indicating on the display of the telecommunication apparatus to correspond to the display structure data;
receiving a selection command to any display structure data inputted by the user; and
modifying a screen establishment of the display into the display structure corresponding to the selection command.

2. The method of claim 1, wherein the display structure includes at least one among an application image area, an application name area and an application icon area, and the telecommunication terminal is a mobile telecommunication terminal or PDA.

3. The method of claim 1, wherein the method further comprises the steps of:
receiving a connection command to a web server providing the display structure data from the user;
executing a connection to the web server through the communication net corresponding to the connection command;
receiving at least one display structure data from the web server;
indicating on the display to correspond to the received display structure data;
receiving a download command of any display structure data among the indicated display structure data inputted by the user;
requesting the transfer of the display structure data corresponding to the download command to the web server through the communication net;
receiving the display structure; and
storing the received display structure data.

4. The method of claim 1, wherein the method further comprises the steps of:
receiving a execution start command of the telecommunication apparatus from the user;
searching the modified display structure; and
indicating on the display of the telecommunication apparatus to correspond to the display structure data.

5. A method of establishing icons to be indicated on a display of a telecommunication apparatus, comprising the steps of:
receiving a list indication command of an application capable of being executed by the telecommunication apparatus from the user;
creating the list including at least one application capable of being executed by the telecommunication apparatus;
indicating the created list on the display;
receiving a selection command to any application among the application included in the list;
searching one previously stored icon data capable of being designated corresponding to the application;
indicating the searched icon data on the display;
receiving an selection command to any icon data among the indicated icon data from the user;
establishing a connection between the selected application and the selected icon data; and
indicating the icon data on the display to correspond to the application.

6. The method of claim 5, wherein the method further comprises the steps of:
receiving a connection command to a web server providing an additional data from the user;
executing a connection to the web server corresponding to the connection command through the communication net;
receiving at least one additional data from the web server;
indicating the received additional data on the display;
receiving a download command to any additional data among the indicated additional data from the user;
requesting the transfer of the additional data corresponding to the download command to the web server through the communication net;
receiving the additional data; and
storing the received additional data and the additional data are an icon data or an additional application data.

7. A method of modifying the arrangement of icons indicated on a display of a telecommunication apparatus corresponding to an application capable of being executed in the telecommunication apparatus, comprising the steps of:
receiving an icon arrangement modification command from the user;
searching previous icon arrangement data being indicated on the display of the telecommunication apparatus;
indicating at least one application designation data in a predefined way with the icon arrangement data on the display of the telecommunication apparatus, wherein the application designation data include one of an application name and the icon;
receiving a selection command to any application designation data among the application designation data from the user;
receiving a location modification data to modify a display location of the display of the telecommunication apparatus to correspond to the selected application designation data;
storing the location modification data to correspond to the application designation data; and
arranging the icon on the display of the telecommunication apparatus using the location modification data.

8. A method of providing a display structure modification data to be capable of modifying the display structure of the user's telecommunication apparatus through a communication net, comprising the steps of:
receiving a connection request from the telecommunication apparatus;
transferring a list of the display structure modification data to the telecommunication apparatus, wherein the display structure modification data include at least one among display structure data, additional application data and icon data;
receiving an transfer request of any display structure modification data from the telecommunication apparatus; and
transferring the display structure modification data corresponding to the transfer request to the telecommunication apparatus.

9. A telecommunication apparatus capable of modifying a display structure, the apparatus comprising:
means of receiving a selection command of a display structure modification command or display structure data;
means of searching at least one display structure data previously stored;
means of indicating the display structure data in a predefined way; and
means of modifying a screen establishment to correspond to the display structure data corresponding to the selection command.

10. A telecommunication apparatus capable of establishing icons capable of executing any application, the apparatus comprising:
means of receiving at least one among a list indication command of an application executable by the telecommunication, a selection command to any application and a selection command to any icon data;
means of creating a list including at least one application capable of being executed by the telecommunication apparatus;
means of searching at least one previously stored icon data capable of being designated corresponding to the application;
means of establishing a connection between the selected application and the selected icon data; and
means of indicating the list or the icon data.

11. A telecommunication apparatus capable of modifying the location of icons indicated corresponding to an executable application in the telecommunication apparatus, the apparatus comprising:
means of receiving at least one among an icon arrangement modification, a selection command to any application designation data and location modification data from the user;
means of searching previous icon arrangement data indicated in the telecommunication apparatus;
means of storing the location modification data corresponding to the application designation data; and
means of indicating at least one application designation data in a predefined way using the icon arrangement data.

12. A computer-readable medium on which commands executable by a digital process unit are typically embodied to execute the display structure modification method of claims 1 to 7, and which is readable by the digital process unit.
